(19) United States
(12) Patent Application Publication
(10) Pub. No.: US 2026/0066703 A1
(43) Pub. Date: Mar. 5, 2026

(54) UNIVERSAL BATTERY PACK

(71) Applicant: International Business Machines Corporation, Armonk, NY (US)

(72) Inventors: Jeremy Ray Fox, Georgetown, TX (US); Martin G. Keen, Cary, NC (US); Sarbajit Kumar Rakshit, KOLKATA (IN); Carolina Garcia Delgado, Zapopan (MX)

(73) Assignee: International Business Machines Corporation, Armonk, NY (US)

(21) Appl. No.: 18/823,981

(22) Filed: Sep. 4, 2024

(51) Int. Cl. H02J 50/10; H01M 10/42

(52) U.S. Cl. CPC H02J 50/10; H01M 10/425; H01M 2010/4271

(57) ABSTRACT

The one or more specified settings associated with the one or more battery cells in the battery pack to facilitate power transfer between the one or more battery cells in the battery pack for a battery pack is configured. The one or more settings associated with the one or more battery cells in the battery pack are accessed. The configuration for the battery pack, until the configuration meets or exceeds the battery power requirements is optimized.

### BACKGROUND

The present invention relates generally to batteries, energy storage and electric mobility systems. More particularly, the present invention relates to a method, system, and computer program designed for optimizing a configuration for a battery pack to meet the varying end-user's demands and needs (e.g., fluctuating power, weight, and real-time adjustment requirements).

Battery packs are essential for powering a wide range of devices, from electric vehicles to portable electronics. These battery packs are typically constructed from individual battery cells connected in a fixed, predetermined arrangement or configuration (e.g., series, parallel, or a combination of both). This fixed configuration limits adaptability of battery pack to different power needs across various applications. Additionally, battery pack construction involves physical connections that increase the overall weight, reducing battery pack utility in applications where weight is a concern. Furthermore, current battery pack technologies do not allow for real-time adjustments based on factors like power needs, battery health, or availability. This inflexibility further limits battery pack applicability in scenarios that require quick adaptability to changing conditions.

It would be desirable to have methods, systems, and computer programs designed for optimizing configurations for battery packs to make them dynamically configurable units, capable of real-time adjustments based on the end-user's demands and needs that would overcome the above disadvantages.

### SUMMARY

The illustrative embodiments provide for optimizing a universal battery pack with individually configurable battery cells. An embodiment includes accessing settings associated with one or more battery cells in the battery pack; The embodiment also includes determining an optimal configuration for the one or more battery cells in the battery pack; and configuring one or more transfer paths between the one or more battery cells in the battery pack based on the determined optimal configuration. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for adjusting a configuration a battery pack with individually configurable battery cells in accordance with an illustrative embodiment;

FIG. 3 depicts a block diagram of an example architecture in accordance with an illustrative embodiment;

FIG. 4 depicts a block diagram of an example of a battery management system (BMS) with an embedded computing module in accordance with an illustrative embodiment;

FIG. 5 depicts a block diagram of an example central control unit (CCU) in accordance with an illustrative embodiment;

FIG. 6 depicts block diagram of an example of a power transfer network (PTN) in accordance with an illustrative embodiment;

FIG. 7 depicts block diagram of an example mechanical design of a battery management system (BMS) accordance with an illustrative embodiment.

### DETAILED DESCRIPTION

The present disclosure addresses the deficiencies described above by providing a process (as well as a system, method, machine-readable medium, etc.) to optimize a configuration for a battery pack with individually configurable battery cells. Improving battery pack functionality matters for several reasons (or problems) appreciated by the inventor(s) of the instant application. First, current battery packs are limited by a fixed number of physically connected batteries, restricting their ability to adapt dynamically to changing power needs. Second, each additional cell in a battery pack adds to the battery pack's overall weight, making the battery pack increasingly heavy and bulky. This additional weight is particularly problematic in industries like electric vehicles and portable electronics, where weight significantly impacts performance and limits the battery pack's adaptability to varying power requirements and efficiency demands of end-users. Disclosed embodiments provide aforementioned advantages/benefits and technological improvements over the existing tools, techniques, and systems for optimize a configuration for a battery pack with individually configurable battery cells, using machine learning analytics and wireless power transfer capabilities.

An illustrative overview of an embodiment of the invention is as follows. The dynamic adjustment of a battery pack with individually configurable battery cells generally comprises six stages: 1) Battery Power Requirements, 2) Battery Cell Selection and Identification, 3) Battery Cell Activation, 4) Connection Type Identification, 5) Battery Cell Pairing, and 6) Battery Cell and Pack Authentication.

### Battery Power Requirements Stage

At the first stage, the battery power requirements are obtained (e.g., received) as inputs. A user graphical interface (e.g., user interface) may be provided to enter the battery power requirements. The battery power requirements may include voltage, current, capacity, state of charge, types of connections (e.g., series, parallel, series-parallel) between one or more battery cells, and specifications (e.g., technical information) for an end-user's application.

### Battery Cell Selection and Identification Stage

At the second stage, the selected number of battery cells (e.g., batteries) for a battery pack are identified (e.g., detected). The user graphical interface (e.g., user interface (UI)) may be provided to select and display the chosen number of battery cells in a software-defined battery pack. This software-defined battery pack corresponds to a physical battery pack, which includes individual physical battery cells. A battery pack may contain at least a circuit module (e.g., a processor) equipped with an identifier (e.g., RFID, radio frequency identifier, unique identifier), a pairing module (e.g., a processor), and an authentication module (e.g., a processor). Additionally, a battery cell may contain at least a circuit module (e.g., a processor) equipped with an identifier (e.g., RFID, radio frequency identifier), a wireless power transfer module (e.g., a processor), a pairing module (e.g., a processor), and an authentication module (e.g., a processor).

### Battery Cell Activation Stage

At the third stage, the circuit modules of the corresponding required number of battery cells in the battery pack are activated using a user graphical interface in some embodiments. It should be noted that data related to a battery cell's heath, voltage, current, capacity, state of charge (e.g., SoC, available power), type of connections (e.g., series, parallel, series-parallel) a battery cell may handle/accept, an identifier or any other necessary specification may be accessed and displayed in a user graphical interface once a computing system detects or recognizes the corresponding physical battery cells, or battery pack.

### Connection Type Identification Stage

At the fourth stage, the types of connections (e.g., series, parallel, series-parallel) to be established between two or more battery cells are determined. The determined types of connections are stored as determined parameters within the optimal configuration data set (e.g., optimal configuration, optimized configuration).

### Battery Cell Pairing Stage

At the fifth stage, how individual battery cells are to be paired (e.g., reconfigured or configured) to create the battery pack is determined, based in part on the battery power requirements, data related to at least one battery cell, and determined parameters. The determined pairings are stored as determined parameters within the optimal configuration data set (i.e., the optimal or optimized configuration).

### Battery Cell and Pack Authentication Stage

At the sixth stage, at least one battery cell is authenticated. During this stage, the authentication module uses the identifier of a battery cell as a key. Based on data related to the battery cells in the battery pack, the battery pack's power requirements, and the determined parameters, at least one battery cell is programmed to conform to the optimal configuration data set defined in the software-defined battery pack. This programming enables wireless power transfers between the battery cells. Although the six stages described above were described in a specific order, it should be understood that other stages may be performed among the six stages or may be performed in an order other than that described, or stages may be adjusted so that they occur at slightly different times. For example, in some embodiments, the fourth stage may occur before the fifth stage.

The following description provides examples of embodiments of the present disclosure, and variations and substitutions may be made in other embodiments. Several examples will now be provided to further clarify various aspects of the present disclosure.

Example 1: A computer-implemented method for optimizing a configuration for a battery pack. The method further comprises accessing, using a battery management system (BMS) associated with one or more battery cells in the battery pack, one or more settings associated with the one or more battery cells in the battery pack. The method further comprises optimizing, based on the one or more settings associated with the one or more battery cells in the battery pack and battery power requirements, the configuration for the battery pack, until the configuration meets or exceeds the battery power requirements. The method further comprises configuring, using the battery management system (BMS) associated with the one or more battery cells in the battery pack, one or more specified settings associated with the one or more battery cells in the battery pack to facilitate power transfer between the one or more battery cells in the battery pack, using one or more wireless transfer paths associated the one or more battery cells in the battery pack, based on the optimized configuration.

The above limitations enable the determination of optimized configuration of battery cells in a battery pack. This capability enhances the efficiency and performance of battery packs through a systematic, computer-implemented approach. By utilizing one battery management system (BMS) to access and retrieve critical settings for each battery cell, the method ensures precise adjustments based on both the specific characteristics of the cells and the overall power requirements of the battery pack. The optimization process aligns the configuration with these requirements, ensuring that the battery pack meets or exceeds performance criteria. Furthermore, the configuration facilitates effective power transfer between cells using wireless transfer paths, which promotes seamless operation and reduces the need for physical connectors. Aspects of the present disclosure improve the reliability and effectiveness of power transfer within the battery pack, contributing to its overall performance and longevity.

Example 2: The limitations of Example 1, where the one or more settings further comprise one or more of the following: a voltage, a current, a capacity, a type of connection, and an identifier. The above limitations advantageously further detail settings such as voltage, current, capacity, type of connection, and identifier, which enhances control and customization of the battery pack. This detailed management allows for precise adjustment of each battery cell's operational settings, leading to improved performance and efficiency tailored to specific battery power requirements. The method also facilitates better monitoring and diagnostics by tracking individual battery cells, optimizing power distribution, and adapting to different battery cell types. Additionally, the method facilitates better monitoring and diagnostics by tracking individual battery cells, optimizing power distribution, and adapting to different battery cell types. Managing these settings also ensures safety by preventing issues like overheating or overcharging, while streamlining the integration of new or replacement battery cells. Aspects of the present disclosure contribute to a more efficient and reliable battery pack.

Example 3: The limitations of Example 2, where the battery power requirements further comprise one or more of the following: a voltage, a current, a capacity, and types of connection. The above limitations advantageously enhance the optimization method's precision and performance by ensuring the battery pack's configuration aligns with the end-user's needs. This method improves power management, allowing for optimal distribution and transfer within the pack, and increases flexibility by adapting to various requirements and connection types. Additionally, the method contributes to greater safety and reliability by preventing issues like overloading or underloading and streamlines integration with other systems, ensuring compatibility and reducing installation issues. Aspects of the present disclosure ensure that the battery pack's configuration aligns closely with the end-user's needs.

Example 4: The limitations of Example 3, where the one or more specified settings further comprise one or more of the following: a voltage, a current, a capacity, an identifier, and types of connection. The above limitations advantageously facilitate better control and configuration of the battery pack by using identifiers and connection types to improve power management. These specified settings ensures that the battery pack's configuration aligns closely with its operational requirements and enhances overall performance and efficiency.

Example 5: The limitations of Example 3, further optimizing the configuration for the battery pack, until the configuration meets or exceeds the battery power requirements further comprises performing a predictive analysis. Additionally, the above limitations enhance the optimization process by allowing for proactive adjustments to the battery pack configuration based on anticipated future power needs and potential issues. This method further improves efficiency by forecasting power requirements and performance trends, enabling the configuration to meet or exceed these needs more effectively. Predictive analysis also supports better performance by adapting to changing conditions and usage patterns, reduces risk by anticipating potential failures or inefficiencies, and aids in long-term planning and maintenance. Aspects of the present disclosure ensure that the battery pack operates more reliably, and safely, effectively addressing battery power requirements.

Example 6: The limitations of Example 5, where the predictive analysis is a Bayesian optimization model. The above limitations advantageously enhance the optimization process/predictive analysis by providing precise and efficient configuration tuning. This Bayesian optimization model systematically explores the configuration space using probabilistic methods, balancing the exploration of new options with the exploitation of known high-performing settings. This method further adapts to changes in battery pack performance and requirements over time, continuously refining configurations based on updated data. Bayesian optimization reduces computational costs by focusing on the most promising areas of the configuration space, thus saving time and resources. Additionally, Bayesian optimization model probabilistic approach helps manage uncertainty, leading to more reliable and robust battery pack configurations. Aspects of the present disclosure ensure the optimization process for the battery pack, enhancing performance, adaptability, and reliability.

Example 7: The limitations of Example 4, the one or more wireless transfer paths are inductive power transfer paths. The above limitations advantageously enhance the battery pack configuration by allowing efficient wireless power transmission between battery cells without physical connections, which reduces energy losses and minimizes wear and tear in the battery cells, thereby improving safety of the battery pack. This method simplifies the battery pack's design by reducing the need for physical connectors, leading to a more streamlined and compact configuration of the battery pack. Additionally, inductive transfer paths increase reliability by minimizing mechanical failures and connection issues, and offer greater flexibility in integrating battery cells, enabling more versatile configurations. Aspects of the present disclosure enhance the efficiency, safety, and reliability of the battery pack while simplifying the design of the battery pack.

Example 8: The limitations of Example 4, further includes electronically disabling the one or more battery cells in the battery pack, which were not included in the optimal configuration. The above limitations advantageously enhance the battery pack's performance by ensuring only the most efficiently configured cells are active. This method further helps extend the battery pack's lifespan by reducing the risk of imbalance and degradation among inactive battery cells. Additionally, this method improves safety by preventing potential issues such as overheating or overcharging associated with non-optimal battery cells. Aspects of the present disclosure contribute to a more efficient, safe, and reliable battery pack, by disabling non-optimal battery cells.

Example 9: A computer usable program product comprising one or more computer readable storage media, and program instructions collectively stored on the one or more computer readable storage media to perform the method according to any of Examples 1-8. The computer program product of Example 9 realizes the benefits described with respect to Examples 1-8. The computer program product of Example 8 can advantageously be implemented into a variety of computer program products.

Example 10: The limitations according to Example 9, where the one or more settings further comprise one or more of the following: a voltage, a current, a capacity, a type of connection, and an identifier. The above limitations realize the technical advantages discussed with respect to Example 2.

Example 11: The limitations according to Example 9, where the battery power requirements further comprise one or more of the following: a voltage, a current, a capacity, and types of connection. The above limitations realize the technical advantages discussed with respect to Example 3.

Example 12: The limitations according to Example 11, where the one or more specified settings further comprise one or more of the following: a voltage, a current, a capacity, an identifier, and types of connection. The above limitations realize the technical advantages discussed with respect to Examples 2, 3 and 4.

Example 13: The limitations according to Example 10, where the optimizing the configuration for the battery pack, until the configuration meets or exceeds the battery power requirements further comprises performing a predictive analysis. The above limitations realize the technical advantages discussed with respect to Examples 2 and 3.

Example 14: The limitations according to Example 13, where the predictive analysis is a Bayesian optimization model. The above limitations realize the technical advantages discussed with respect to Examples 3, 4, and 5.

Example 15: The limitations according to Example 12, further physically removing the one or more battery cells in the battery pack, which were not included in the optimal configuration The above limitations realize the technical advantages by enhances the battery pack's performance by ensuring that only the most efficient and well-configured battery cells are in use. This operation increases safety by reducing the risk of issues such as overheating and overcharging associated with underperforming cells. This operation also extends the battery pack's lifespan by preventing imbalance and degradation among the remaining cells. Additionally, physically removing non-optimal battery cells simplifies the internal structure of the battery pack, improving reliability and reducing potential points of failure, while optimizing space utilization for a more compact and efficient design of the battery pack.

Example 16: The limitations according to Example 12, further including electronically disabling the one or more battery cells in the battery pack, which were not included in the optimal configuration. The above limitations realize the technical advantages discussed with respect to Examples 4 and 8.

Example 17: A system comprising one or more processors and one or more computer-readable storage media collectively storing program instructions which, when executed by the one or more processors, are configured to cause the one or more processors to perform the method according to any of Examples 1-8. The system of Example 17 realizes the benefits described with respect to Examples 1-8. The system of Example 15 can advantageously be implemented into a variety of computing devices.

Example 18: The limitations according to Example 17, the one or more settings further comprise one or more of the following: a voltage, a current, a capacity, a type of connection, and an identifier. The above limitations realize the technical advantages discussed with respect to Example 2.

Example 19: The limitations according to Example 18, where the battery power requirements further comprise one or more of the following: voltage, a current, a capacity, and types of connection. The above limitations realize the technical advantages discussed with respect to Example 3.

Example 20: The limitations according to Example 19, where the one or more specified settings further comprise one or more of the following: a voltage, a current, a capacity, an identifier, and types of connection. The above limitations realize the technical advantages discussed with respect to Example 4.

Example 21: A computer-implemented method for optimizing a configuration for a battery pack. The method further comprises accessing, using a battery management system (BMS) associated with one or more battery cells in the battery pack, one or more settings associated with the one or more battery cells in the battery pack. The method further comprises optimizing, based on the one or more settings associated with the one or more battery cells in the battery pack and battery power requirements, the configuration for the battery pack, until the configuration meets or exceeds the battery power requirements. The method further comprises configuring, using the battery management system (BMS) associated with the one or more battery cells in the battery pack, one or more specified settings associated with the one or more battery cells in the battery pack to facilitate power transfer between the one or more battery cells in the battery pack, using one or more wireless transfer paths associated the one or more battery cells in the battery pack, based on the optimized configuration. The method further authenticating, using the battery management system (BMS) associated with the one or more battery cells in the battery pack, the one or more battery cells in the battery pack, based on the optimized configuration.

The above limitations enable the determination of optimized configuration of battery cells in a battery pack. This capability enhances the efficiency and performance of battery packs through a systematic, computer-implemented approach. By utilizing one battery management system (BMS) to access and retrieve critical settings for each battery cell, the method ensures precise adjustments based on both the specific characteristics of the cells and the overall power requirements of the battery pack. The optimization process aligns the configuration with these requirements, ensuring that the battery pack meets or exceeds performance criteria. Furthermore, the configuration facilitates effective power transfer between cells using wireless transfer paths, which promotes seamless operation and reduces the need for physical connectors. By authenticating cells based on the optimized configuration, the method enhances security and reliability, ensuring that only validated cells contribute to the battery pack's operation. Aspects of the present disclosure improve the reliability, security and effectiveness of power transfer within the battery pack, contributing to its overall performance and longevity.

Example 22: The limitations according to Example 21, the one or more settings further comprise one or more of the following: a voltage, a current, a capacity, a type of connection, and an identifier. The above limitations realize the technical advantages discussed with respect to Example 2.

Example 23: The limitations according to Example 22, where the battery power requirements further comprise one or more of the following: voltage, a current, a capacity, and types of connection. The above limitations realize the technical advantages discussed with respect to Example 3.

Example 24: The limitations according to Example 23, where the one or more specified settings further comprise one or more of the following: a voltage, a current, a capacity, an identifier, and types of connection. The above limitations realize the technical advantages discussed with respect to Example 4.

Example 25: A computer usable program product comprising one or more computer readable storage media, and program instructions collectively stored on the one or more computer readable storage media to perform the method according to any of Examples 21-24. The computer program product of Example 25 realizes the benefits described with respect to Examples 21-24. The computer program product of Example 25 can advantageously be implemented into a variety of computer program products.

Aspects of the present disclosure can be implemented in a variety of technical use cases. The following use cases are merely exemplary and are not intended to limit the scope of the disclosure.

In a first use case, Tisha, an outdoor enthusiast, uses a sophisticated portable battery pack to power her various devices like a GPS, camera, and smartphone during her remote hikes. The battery pack is equipped with advanced Battery Management Systems (BMS) that monitor the settings of each battery cell. As Tisha begins her adventure, the BMS optimizes the battery pack's configuration to meet the power requirements of her devices, dynamically adjusting the configuration and redistributing power as needed. The BMS also configures wireless transfer paths to ensure efficient power distribution between cells. This allows Tisha to rely on a single, optimized battery pack, ensuring a stable power supply for all her devices throughout her trip and reducing the need for multiple batteries. This approach addresses optimized configuration of battery cells in a battery pack, as exemplified in Examples 1-25 discussed above.

In a second use case, for a small community hospital example, a computer-implemented method for optimizing battery pack configuration involves accessing real-time settings from Battery Management Systems (BMS) associated with each battery cell to monitor their status. Based on these settings and the hospital's power requirements, the method dynamically optimizes the battery pack configuration to meet or exceed the required power levels. Once optimized, the BMS reconfigures the settings of the battery cells, including voltage and current limits, and facilitates efficient power transfer using wireless paths if needed, ensuring reliable and adaptable backup power for the hospital's essential systems during outages. This approach addresses optimized configuration of battery cells in a battery pack, as exemplified in Examples 1-25 discussed above.

In a third use case, in renewable energy storage context the computer-implemented method for optimizing battery pack configuration would involve the following: in a solar or wind farm, the method begins by accessing real-time settings from Battery Management Systems (BMS) associated with each battery cell to monitor their status, such as charge levels and health. Using these settings and the fluctuating energy production levels from solar panels or wind turbines, the system optimizes the battery pack configuration to efficiently store excess energy when production is high and meet grid demands during periods of low renewable generation. Once the optimal configuration is determined, the BMS reconfigures the battery cells' settings, including voltage and current limits, and manages power transfer between cells, potentially using wireless paths to ensure effective energy storage and dispatch, thereby enhancing the flexibility and efficiency of the renewable energy storage system. This approach addresses optimized configuration of battery cells in a battery pack, as exemplified in Examples 1-25 discussed above.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

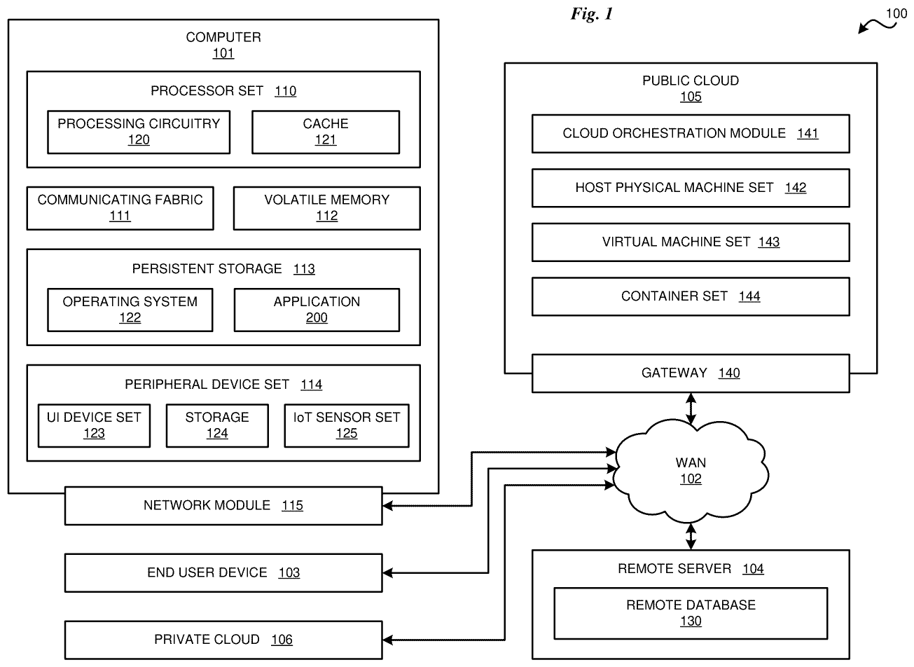

With reference to FIG. 1, this figure depicts a block diagram of a computing environment 100. Computing environment 100 contains an example of an environment for the execution of at least some computer code involved in performing the inventive methods, such as an example application 200 for optimizing a battery pack with individually configurable battery cells. The following are definitions for terms used throughout the disclosure. “Battery cell” is a term used in the present disclosure to describe a device that stores and converts chemical energy into electrical energy through electrochemical reactions; a “battery cell” may consist of one or more electrochemical cells, each containing two electrodes (a positive cathode and a negative anode) and an electrolyte that facilitates the flow of ions between the electrodes; a “battery cell” may also include several additional components: the battery itself, which stores and converts chemical energy into electrical energy through electrochemical reactions; a bidirectional inductive coil (or receiver and transmitter coils), functioning as both a transmitter and a receiver, embedded in the battery cell to receive, transmit, and convert electromagnetic fields into electrical energy/chemical energy; a charging circuit that manages the power received and regulates it for safe battery charging; a rectifier that converts the alternating current (AC) from the inductive coil into direct current (DC) for the battery; an inverter that converts the direct current (DC) from the battery inductive coil into alternating current (AC) for the inductive coil; a power management integrated circuit (IC) that controls the charging process; thermal management components like heat sinks to handle heat generated during charging; and a control system that manages communication between the external control circuit and the battery cell to ensure efficient power transfer and adherence to wireless one or more charging protocols; “battery cells” may be used to provide portable energy for a wide range of applications, from powering small electronic devices like smartphones and laptops to larger applications such as electric vehicles and energy storage systems; the term “battery cell” may be used interchangeably with the term “battery”; the term “battery pack” is used in the present disclosure to describe an assembly of one or more individual battery cells that are connected together to provide a specific voltage, current, resistance, and capacity; the battery cells within a “battery pack” may be arranged in series, parallel, or a combination of both to achieve the desired electrical characteristics, such as voltage, current, and energy storage; “Pairing” or “pair” is a term used in this present disclosure to describe the process of wirelessly connecting or coordinating two or more individual battery cells in a battery pack to achieve a desired electrical configuration for the battery pack or in a specific configuration to form a functional battery pack; for example, when battery cells are paired wirelessly in series, their collective voltage increases. Conversely, when battery cells are paired wirelessly in parallel, each cell battery maintains the same voltage while their collective capacity increases. In a series-parallel configuration, which combines both series and parallel wireless connections, both the collective voltage and capacity may be increased; for instance, if a battery pack needs to supply 10 volts at 1 mAh (e.g., milli-ampere hour) and consists of two battery cells, each with a nominal voltage of 5 volts at 1 mAh, pairing these battery cells wirelessly in series involves coordinating them through their respective wireless transfer paths, allowing the paired battery cells to collectively provide the battery pack with 10-volts at 1 mAh; alternatively, if a battery pack needs to supply 10-volts at 2 mAh, and you have two battery cells, each with a nominal voltage of 10-volts at 1 mAh, pairing these battery cells wirelessly in parallel ensures that the paired cells collectively provide the battery pack with 10-volts at 2 mAh; in a more complex series-parallel configuration, if a battery pack needs to supply 14.8-volts with a capacity of 4,000 mAh and consists of 8 battery cells, each with a nominal voltage of 3.7-volts and a capacity of 2,000 mAh, the battery cells can first be paired wirelessly in two sets of four cells in series. Each set would then have a total voltage of 14.8-volts while maintaining the 2,000 mAh capacity; These two series sets can then be paired wirelessly in parallel, keeping the voltage at 14.8-volts (voltage) but doubling the capacity to 4,000 mAh; this series-parallel configuration allows the paired battery cells to collectively provide the battery pack with 14.8-volts with a capacity of 4,000 mAh; those skilled in the art will appreciate that the battery pack would include a rectifier circuit to provide a 10-volt (or 14.8-volt) DC (direct current) output, generated from the AC (alternating current) power supplied by the battery cells in the above examples, or omit the rectifier circuit to produce a 10-volt (or 14.8-volt) AC output from the battery pack, generated directly from the AC power supplied by the battery cells; “pairing” may include setting up the transfer of power or energy between battery cells through various wireless power transfer paths (e.g., bi-directional inductive coils of the battery cells wirelessly connected in series or parallel), matching battery cells based on their characteristics, such as voltage, current, capacity, and internal resistance, and/or, establishing the necessary physical and electrical configurations and/or connections to ensure performance and efficient power distribution within the battery pack; “pairing” may also involve requesting the battery management system (BMS) of a battery cell to adjust settings such as voltage, current, capacity, and internal resistance (e.g., specified settings), depending on the type of battery cell, to achieve a desired electrical configuration for the battery pack; This adjusting or specifying settings aspect of “paring” may be accomplished through various approaches (including others appreciated by those skilled in the art): one approach is modifying the charging circuit using a buck (step-down) or boost (step-up) converter to regulate the output voltage from the inductive charging receiver of the battery cell; If the battery cell has a programmable charge controller, its settings can also be adjusted; another approach is altering the inductive coil setup of the battery cell, where changing the coil design, such as the number of turns and size, or adjusting the distance between the transmitter and receiver coils or bi-directional inductive coil, can impact the induced voltage; additionally, adjusting the power supply to the transmitter coil or fine-tuning its operating frequency can influence the voltage induced in the receiver coil, thereby allowing for control of the voltage at the battery cell end; additionally, a power transfer network (PTN) can be employed to manage and optimize the flow of electrical power between battery cells, a battery pack, and external systems; power transfer network (PTN) dynamically reconfigures connections between components based on real-time monitoring of factors such as charge levels, voltage, and temperature; this reconfiguration enables the power transfer network (PTN) to adapt to varying power demands. Additionally, power transfer network (PTN) can incorporate wireless power transfer capabilities and manage faults by isolating underperforming cells, ensuring reliable and efficient power transfer; the term “pairing” may be used interchangeably with the term “configuring” or “re-configuring”; “Power transfer path” is a term used in the present disclosure to describe the technology used to transmit electrical energy from one or more power sources (e.g., a battery cell) to one or more electrical devices (e.g., a battery cell), without the need for physical connectors or wires; “power transfer path” may include such methods such as inductive power transfer, wireless energy transmission, or wireless charging; “authentication” or “authenticating” is a term used in the present disclosure to describe the security process of verifying or checking one or more unique identifiers associated with the one or more battery cells, respectively, confirming that the one or more battery cells meet or satisfy the one or more requirements or specifications and that the one or more battery cells are authorized to be used in the battery pack for power transfer; “authentication” may facilitate the maintenance of security, integrity, and performance of the battery pack by preventing unauthorized or incompatible components (e.g., unauthorized battery cells) from being used in the battery pack; “Predictive Analysis” is a term used in the present disclosure to describe a technique, algorithm, or computer code that uses statistical algorithms and machine learning (e.g., Bayesian optimization model) to forecast future outcomes by analyzing historical data; “Predictive Analysis” may involves collecting past data of battery cells and battery packs, identifying patterns and relationships, and building models to predict future events, such as determining when to place a battery pack into power-saving mode; “Setting” or “Settings” is a term used in the present disclosure to describe specific information associated with each battery cell in a battery pack that is used by a computing system to manage and optimize the performance of the battery pack or battery cells; “Settings” may include various metrics and attributes, that may be accessed or specified, such as the health of the battery cell, voltage, current, temperature, capacity, power output, state of charge (SoC), available power, connection type (e.g., series, parallel, series-parallel), and unique identifiers (e.g., keys); the term “settings” or “setting” may be used interchangeably with the terms “data,” “battery data request,” “target parameter,” or “battery data”; “Battery Power Requirements” is a term used in the present disclosure to describe specific needs of an end-user for a battery pack or battery cells, including parameters such as voltage, current, power, temperature, capacity, state of charge, and connection types (e.g., series, parallel, series-parallel) between battery cells or within the battery pack; “Battery Power Requirements” term also includes any technical specifications or other requirements necessary to meet the functional needs of the end-user's application, as detailed in the present disclosure; the term “Battery Power Requirements” may be used interchangeably with the terms “input requirements”or “user-defined power requirements”;

In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

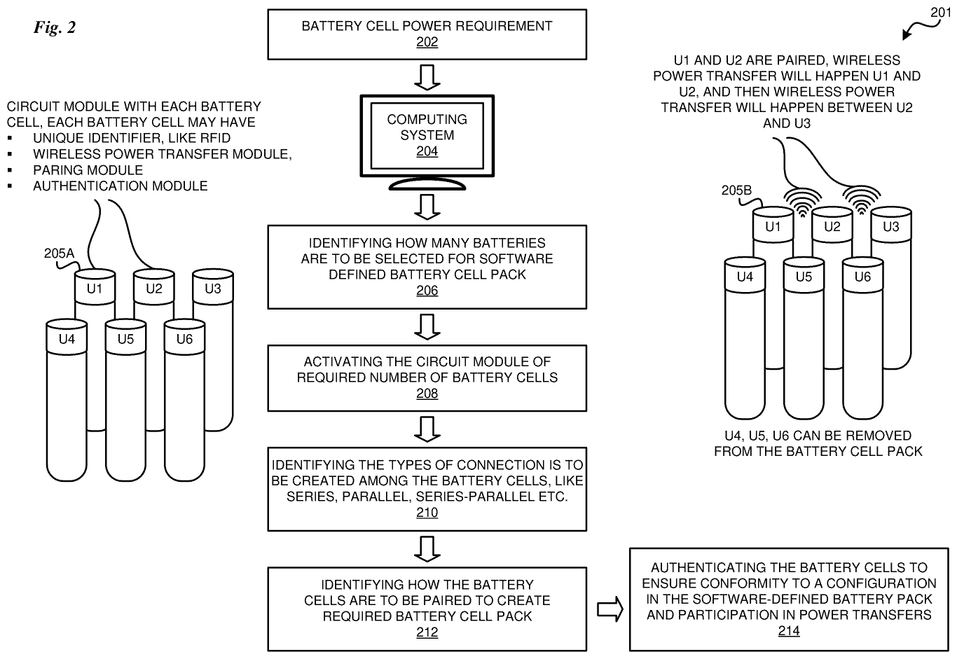

With reference to FIG. 2, this figure depicts a flowchart diagram 201 of an embodiment for adjusting a configuration of a battery pack with individually configurable battery cells. The illustrated embodiment includes the following method steps.

Step 202 initiates the method. At step 202, the battery power requirements are obtained (e.g., received) as inputs and fed into computer system 204 (e.g., computer 101). A user graphical interface (e.g., user interface (UI) device set 123) may be provided to enter the battery power requirements, which may relate to a battery pack or one or more battery cells. The battery power requirements may include voltage, current, power, temperature, capacity, power, state of charge, and types of connections (e.g., series, parallel, series-parallel) between one or more battery cells, battery pack, and specifications (e.g., technical information) for an end-user's application or any other specification necessary to implement the functionality of flowchart diagram 201.

At step 206, the selected number of battery cells (e.g., batteries) for a battery pack are identified (e.g., detected) via computing system 204. The user graphical interface (e.g., user interface (UI) device set 123) may be provided to select and display the chosen number of battery cells (e.g., U1-U6) in a software-defined (e.g., illustrated) battery pack 205a-b. This software-defined battery pack 205a-b corresponds to a physical battery pack, which includes individual physical battery cells (not shown). Software-defined battery pack 205a illustrates the state of the battery pack prior to the initiation of pairing/authentication, while software-defined battery pack 205b shows the state of the battery pack after pairing/authentication has been initiated. In certain embodiments, a physical battery pack may include at least one circuit module (e.g., computer 101, processor set 110) equipped with an identifier (e.g., RFID, radio frequency identifier), a pairing module (e.g., computer 101, processor set 110, network module 115), and an authentication module (e.g., computer 101, processor set 110, network module 115). Additionally, depending upon the embodiment, a battery cell may also contain at least one circuit module (e.g., computer 101, processor set 110) equipped with an identifier (e.g., RFID, radio frequency identifier), a wireless power transfer module (e.g., computer 101, processor set 110, network module 115), a pairing module (e.g., computer 101, processor set 110, network module 115), and an authentication module (e.g., computer 101, processor set 110, network module 115). In some embodiments, computing system 204 may detect or recognize the corresponding physical battery cells, or battery pack, or both through wireless pairing (e.g., Bluetooth) or through a wired connection (e.g., USB, ethernet, firewire) between the battery pack (or battery cells) and computing system 204.

At step 208, the circuit modules of the corresponding required number of battery cells in the battery pack are activated, via computing system 204, using a user graphical interface (e.g., selecting battery cells in software-defined battery 205a-b). Once the computing system 204 detects or recognizes the corresponding physical battery cells or battery pack, data (e.g. settings) associated with each battery cell—such as health, voltage, current, temperature, capacity, power, state of charge (SoC, available power), type of connections (e.g., series, parallel, series-parallel), identifier, or any other relevant specifications—may be accessed and displayed in the user graphical interface (e.g., UI device set 123).

At step 210, the types of connections (e.g., series, parallel, series-parallel) to be established between two or more battery cells are determined using computing system 204. These determined types of connections (i.e., connection types: series, parallel, series-parallel) are then stored as parameters within the optimal configuration data set (i.e., the optimal configuration).

At step 212, how individual battery cells should be paired (e.g., reconfigured or configured) to form the battery pack is determined by computing system 204. This determination is based on factors such as the battery power requirements, data (e.g., settings) related to at least one battery cell, and other determined parameters. The resulting pairings are stored as parameters within the optimal configuration data set (i.e., the optimal or optimized configuration). For example, if an end-user requires a battery pack that supplies 14.8 volts DC with a capacity of 4 ampere-hours (Ah) (i.e., battery power requirements) and consists of 8 battery cells (identified as U1-U8) each with a nominal voltage of 3.7 volts and a capacity of 2,000 watt-hours (Wh) (i.e., data or settings), the battery cells can be paired wirelessly in two sets of four cells in series (e.g., Set 1: U1-U4 and Set 2: U5-U8). Each set would then have a total voltage of 14.8 volts while maintaining a capacity of 2 Ah. These two series sets can subsequently be paired wirelessly in parallel, preserving the voltage at 14.8 volts while doubling the capacity to 4 Ah. This series-parallel configuration enables the paired battery cells to collectively provide the battery pack with the desired 14.8 volts and 4 Ah capacity, meeting the battery power requirements. The resulting pairings—Set 1: U1-U4 in series, Set 2: U5-U8 in series, and the two sets paired in parallel—are stored as parameters in the optimal configuration data set. Specifically, this includes: U1 paired with U2 in series, U2 paired with U3 in series, U3 paired with U4 in series; U5 paired with U6 in series, U6 paired with U7 in series, U7 paired with U8 in series; and finally, Set 1 paired with Set 2 in parallel.

At step 214, at least one battery cell is authenticated using the battery cell's respective authentication module, which is accessed through and controlled by computing system 204 or the battery pack's authentication module. During this step, the respective authentication module uses the battery cell's unique identifier (e.g., identifier) as a key. Based on data related to the battery cells (e.g., settings), the battery pack's power requirements, and the determined parameters, the respective authentication module programs the battery cell to conform to the optimal configuration defined in the software-defined battery pack 205a-b; This authentication process also authorizes the battery cell's participation in the battery pack, enabling wireless power transfers between the battery cells.

Referring to FIG. 2, the left side of the flowchart diagram shows the battery cells (e.g., U1-U6) in a software-defined battery pack 205a in a pre-paired and pre-authenticated state. After executing the method steps outlined in FIG. 2, these battery cells are reconfigured according to the optimal configuration data set, resulting in a software-defined battery pack 205b. The optimal configuration, depicted on the right side of the flowchart diagram, shows the battery cells (e.g., U1-U3 in series) in their optimized state (software-defined battery pack 205b). In this configuration, power is transferred sequentially (e.g., in series) from U1 to U2, and then from U2 to U3 to deliver the battery pack's output. Battery cells U4, U5, and U6, which are not included in the end-user's optimal configuration, may be physically removed or electronically disabled to reduce the battery pack's weight.

Consider a scenario for software-defined battery pack 205a-b where an end-user specifies battery power requirements for a drone that must adhere to a specific weight limit for optimal flight performance. The user's battery requirements dictate that the drone's battery pack must provide a total capacity of 100 ampere-hours (Ah). During the configuration/authentication process described in FIG. 2, computing system 204 or the battery pack evaluates the capacities of the available battery cells (e.g., U1-U6). For instance, if battery cells U1, U2, and U3 each provide 40 Ah, 35 Ah, and 30 Ah respectively, then U1, U2, and U3, when connected in series, meet or exceeds the required capacity of 100 Ah (e.g., a battery power requirement). U1, U2, and U3 are then paired and authenticated to participate in the drone's battery pack configuration.

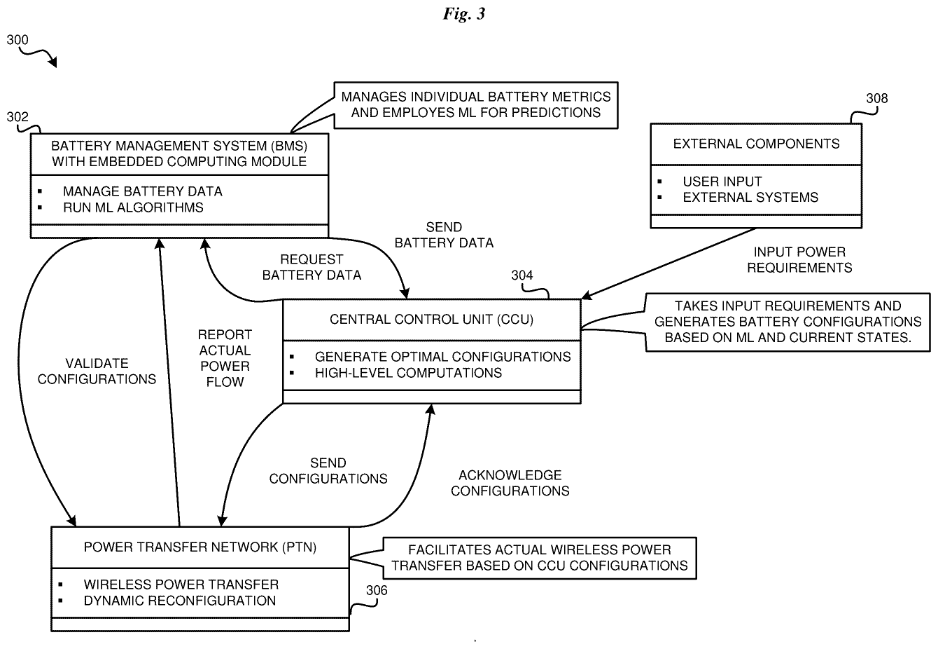

With reference to FIG. 3, this figure depicts a block diagram 300 of an embodiment of an architecture. The illustrated embodiment includes modules: battery management system (BMS) with embedded computing module 302 (e.g., computer 101, processor set 110, network module 115), external component module 308 (e.g., computer 101, processor set 110, network module 115), central control unit module (CCU) 304 (e.g., computer 101, processor set 110, network module 115), and power transfer network (PTN) 306. Battery management system (BMS) with embedded computing module 302 manages individual battery metrics and employs machine learning for predictive analysis. Machine learning (ML) for predictive analysis in this context involves configuring the BMS to process real-time data, apply feature engineering (e.g., battery power requirements), and utilize algorithms like Bayesian optimization to forecast battery pack and cells performance and anticipate failures based on historical behavior. A Bayesian optimization may be used to determine the optimal settings (minimum or maximum) for complex, costly, or stochastic functions by efficiently learning from previous evaluations. A key aspect of Bayesian optimization process is hyperparameter tuning, which involves iteratively adjusting and evaluating hyperparameters to achieve the best performance. Search methods can be either uninformed or informed. Uninformed search tests various hyperparameters independently, similar to experimenting with different battery configurations without guidance on which might be most efficient. In contrast, Bayesian optimization enhances efficiency by focusing the search on likely optimal areas. For example, in optimizing battery settings for energy storage, the process involves initial sampling to establish performance baselines, learning and modeling to predict optimal configurations, smart searching that balances exploration of promising yet uncertain settings with exploitation of configurations showing known good results, and continuous refinement of the model with new data to improve accuracy. The benefits of Bayesian optimization include increased efficiency and adaptability, particularly for complex problems where the relationship between hyperparameters and performance is not straightforward, as in optimizing of battery cells with a battery pack.

Referring again to FIG. 3, battery management system (BMS) with embedded computing module 302 also processes battery data requests (e.g., accessed or specified settings) and transmits battery data (e.g., accessed setting) to central control unit module (CCU) 304. External components 308 may present as a graphical user interface (e.g., user interface (UI) device set 123) for allowing end-users to input data regarding external system requirements (e.g., battery power requirements). Central control unit module (CCU) 304 takes battery power requirements as input (e.g., input power requirements) and generates battery pack configurations based on a machine learning and predictive analysis and current states of one or more battery cells and battery pack. Central control unit module (CCU) 304 also outputs battery pack configurations (e.g., optimal configurations) and acknowledges or validates the configurations of battery packs and cells. Other functions, which may be included central control unit module (CCU) 304, are reporting actual power flows and validating optimal/optimized configurations. Power transfer network (PTN) module 306 facilitates actual wireless power transfer based on optimal configurations received from central control unit module (CCU) 304. Power transfer network (PTN) module 306 can dynamically reconfigure battery packs and battery cells to accommodate changes in wireless power transfer requirements of the battery cells. Those skilled in the art will recognize that, although FIG. 3 describes the modules in the context of a battery pack, one or more of these modules may be distributed among the battery pack, the individual battery cells, or external systems (e.g., computing system 204).

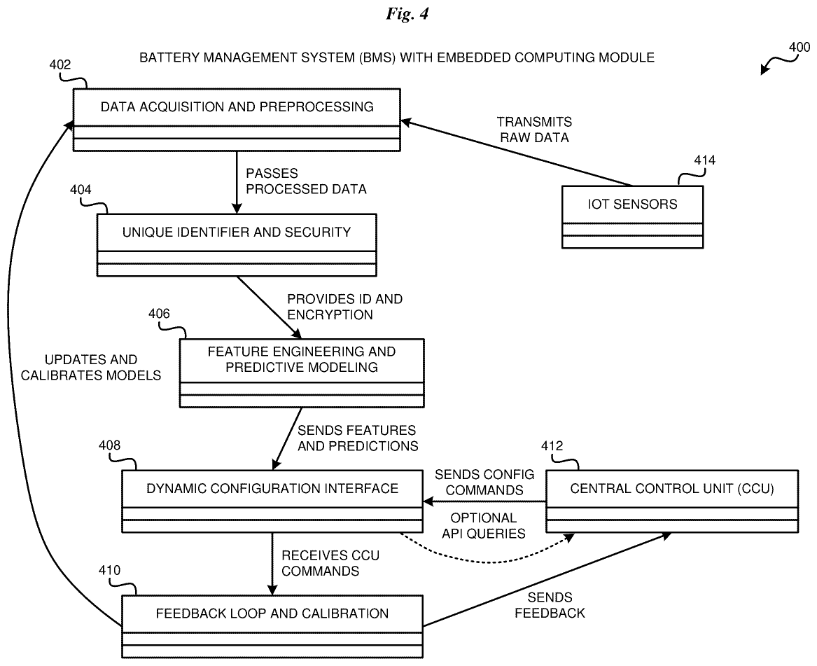

With reference to FIG. 4, this figure depicts a block diagram 400 of an embodiment of a battery management system (BMS) with an embedded computing module. In some embodiments, a battery cell may include a battery management system (BMS) with an embedded computing module (e.g., circuit module, module 302, computer 101, processor set 110, and network module 115). In other embodiments, a battery pack may include one battery management system (BMS) with an embedded computing module. In other embodiments, the battery management system (BMS) with an embedded computing module may be distributed across one or more battery cells and the battery pack. The illustrative embodiment of a battery management system (BMS) with an embedded computing module may further include sub-modules: data acquisition and preprocessing 402, unique identifier and security sub-module 404, iot sensors sub-module 414, feature engineering and predictive modeling sub-module 406, dynamic configuration interface sub-module 408, central control unit (ccu) sub-module 412, and feedback loop and calibration sub-module 410.

Referring still to FIG. 4, data acquisition and preprocessing 402 sub-module involves receiving real-time raw data (e.g., voltage, current, temperature, state of charge or settings) as input from Internet of Things (IoT) sensors sub-module 414 and processes this data using normalization techniques to create a clean, unified dataset, referred to as preprocessed data. This preprocessed is then forwarded to the Unique Identifier and Security Sub-module 404 and other sub-modules. Unique Identifier and Security Sub-module 404 handles encryption and decryption, ensuring secure management of battery cell identifiers, which may include RFID or QR codes encrypted with public-key cryptography to protect sensitive information and prevent unauthorized access. Additionally, Unique Identifier and Security Sub-module 404 receives processed data as input from Data acquisition and preprocessing 402 sub-module.

IoT Sensors Sub-module 414 collects and transmits real-time data such as voltage, current, temperature, and state of charge from one or more battery cells. Feature Engineering and Predictive Modeling Sub-module 406 updates and calibrates internal models (e.g., Time-series ARIMA models, and Bayesian optimization) based on feature engineering e.g., battery power requirements, user-defined power requirements such as voltage, current, energy density, and connection types (series, parallel)) derived from preprocessed data to capture underlying patterns in battery cell or battery pack behavior. Time-series ARIMA (Autoregressive integrated moving average) models and Bayesian optimization for model hyperparameter tuning are used for predicting the future state of a battery cell or battery pack. Feature Engineering and Predictive Modeling Sub-module 406 enables the Battery Management System (BMS) to predict battery cell failures (e.g., likely failures) or determine optimal pairing/unpairing of cells to meet energy demands.

Dynamic Configuration Interface Sub-module 408 receives configuration commands and queries from Central Control Unit (CCU) 412 and forwards to Feedback Loop and Calibration Sub-module 410. Dynamic Configuration Interface Sub-module 408 exposes API (application program interfaces) for dynamic configuration of battery pack or cells, allowing mode changes (e.g., series, parallel) or selective disabling of battery cells. Central Control Unit (CCU) Central control unit (CCU) submodule 412 manages communication with Dynamic Configuration Interface submodule 408, ensuring effective BMS operation. RESTful (representational state transfer) APIs used for communication between the battery management system (BMS) and Central control unit (CCU) 412, while MQTT (Message Queuing Telemetry Transport) protocol facilitates data transmission from for IoT sensor sub-module 414 data transmission. In some embodiments, central control unit (CCU) sub-module 412 may be external to BMS with embedded computing module 412.

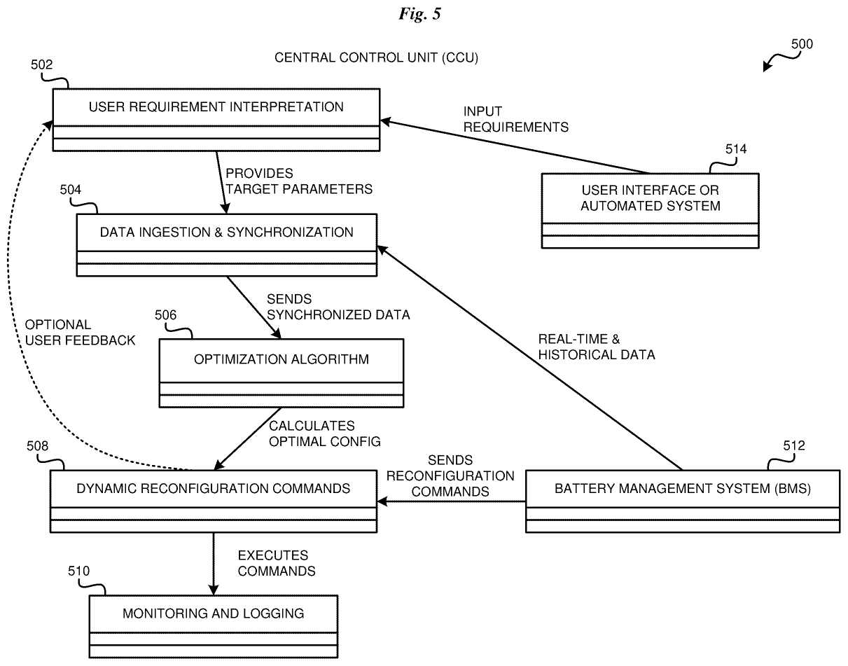

With reference to FIG. 5, this figure depicts a block diagram 501 of an embodiment of a central control unit (CCU). The illustrative embodiment includes sub-modules: user requirement interpretation sub-module 502, data ingestion and synchronization sub-module 504, user interface or automated system sub-module 514, optimization algorithm sub-module 506, dynamic reconfiguration commands sub-module 508, monitoring and logging sub-module 510 and battery management (BMS) sub-module 512.

User requirement interpretation sub-module 502 processes target parameters (e.g., specified settings) and receives input requirements (e.g., battery power requirements) from user interface (e.g., user interface (UI) device set 123) or automated system sub-module 514 (computer system 204, computer 101). User requirement interpretation sub-module 502 interprets user-defined power requirements (i.e., input requirements or battery power requirements) and converts them into target parameters (i.e., specified parameters) such as voltage, current, and energy density, as output. Data ingestion and synchronization sub-module 504 receives these target parameters from user requirement interpretation sub-module 502, processes optional user feedback, and sends synchronization data to optimization algorithm sub-module 506. Data ingestion and synchronization sub-module 504 may ingest real-time and historical data from battery management system sub-module 512, synchronizing and storing it in a high-speed cache (not shown) for consistency.

Optimization algorithm sub-module 506 receives time-series synchronized data as input from data ingestion and synchronization sub-module 504. Additionally, optimization algorithm sub-module 506 computes the optimal configuration (e.g., series, parallel, series-parallel) for the battery pack based on the target parameters (e.g., specified settings) and current battery cell states. Optimization algorithm sub-module 506 then calculates and outputs the optimal configuration data (e.g., optimal configuration). In some embodiments, Optimization algorithm sub-module 506 provides optional user feedback.

Dynamic reconfiguration commands sub-module 508 receives the calculated optimal configuration, and reconfiguration commands as input and transmits commands to monitoring and logging sub-module 510 as output. Dynamic reconfiguration commands sub-module 508 may convert the calculated configurations into a set of dynamic reconfiguration commands. These dynamic reconfiguration commands are sent from battery management system sub-module (BMS) 512 via a secure API. In some embodiments, communication protocols used between sub-modules include: RESTful APIs using JSON (JavaScript Object Notation) or XML (Extensible Markup Language) for data interchange; WebSockets (e.g., computer communications protocol, providing a simultaneous two-way communication channel over a single Transmission Control Protocol (TCP)) for real-time data streaming and instructing submodule to reconfigure the battery pack accordingly. Monitoring and logging sub-module 510 monitors dynamic reconfiguration commands sub-module 508 and other sub-modules continuously, logging and monitoring the state of the battery pack or battery cells. Monitoring and logging sub-module 510 logs performance metrics and performance metrics may be used to adjust optimization algorithms sub-module 506 based on feedback from battery management system sub-module (BMS) 512. Additionally, IT standards include the use of HTTPS (e.g., Hypertext Transfer Protocol Secure) for secure API communications and compliance with OpenTelemetry (e.g., open-source standard and set of technology that captures and exports data from cloud native applications) for distributed traces and metrics.

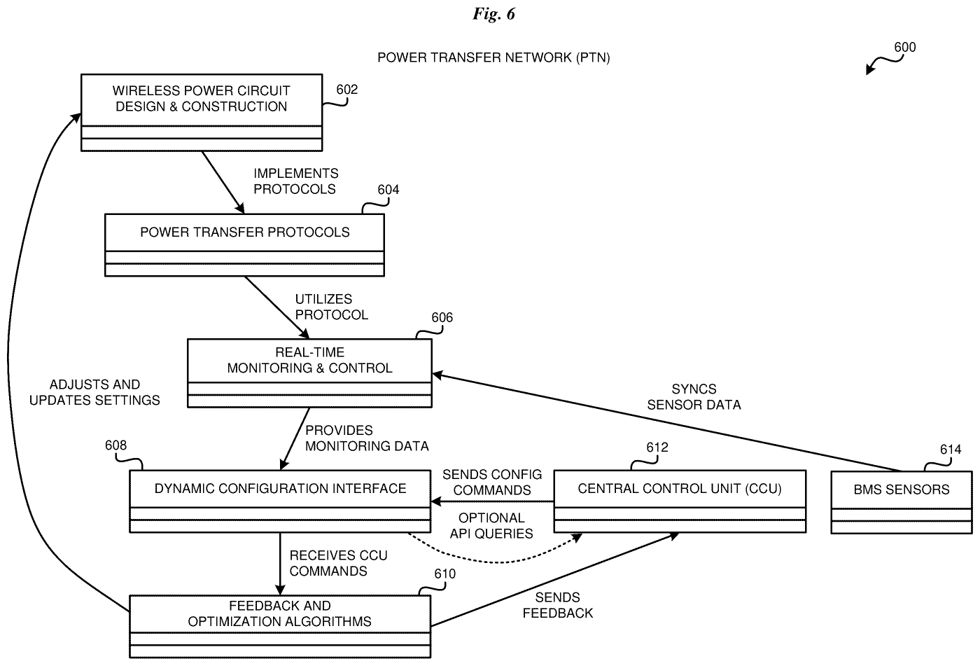

With reference to FIG. 6, this figure depicts a block diagram 601 of an embodiment of a power transfer network (PTN). The illustrative embodiment includes wireless power circuit design and construction sub-module 602, power transfer protocols sub-module 604, real-time monitoring and control sub-module 606, dynamic reconfiguration interface sub-module 608, and feedback and optimization algorithms sub-module 610, and central control unit (CCU) sub-module 612 and BMS Sensors sub-module 614. Wireless power circuit design and construction sub-module 602 implements protocols and interfaces with power transfer protocols sub-module 604. Wireless power circuit design and construction sub-module 602 incorporates inductive coupling circuits within a battery cell to facilitate wireless power transfer between battery cells. These inductive coupling circuits are designed for high efficiency and low electromagnetic interference, serving as the basis for dynamic reconfiguration of the power transfer links among battery cells. Wireless power circuit design and construction sub-module 602 may use the IEEE P1901 for powerline communication (e.g., a standard for high-speed communication devices via electric power lines) and Qi wireless charging standard for inductive coupling. Power transfer protocols sub-module 604 receives implements protocols as input and output utilizes protocols to regulate the initiation, termination, and modulation of power transfer between paired battery cells. Power transfer protocols sub-module 604 provides a stable power flow and mitigates the risks of overcharging or overheating. Power transfer protocols sub-module 604 also uses gradient boosting for optimizing power transfer settings and reinforcement learning for real-time adjustments. Real-time monitoring and control module sub-module 606 adjusts and updates settings, providing monitoring data and receiving sensor data from BMS sensors sub-modules 614. Real-time monitoring and control module sub-module 606 utilizes embedded sensors and central control unit sub-module 612 for real-time measurements of power flow, efficiency, and circuit health. Real-time monitoring and control module sub-module 606 receives data from both the BMS sensors sub-module 614 and the central control unit sub-module 612 for analysis and decision-making. Dynamic reconfiguration interface sub-module 608 receives monitoring data, commands, and API queries. Dynamic reconfiguration interface sub-module 608 outputs received CCU commands and provides feedback and optimization algorithms sub-module 610. Dynamic reconfiguration interface sub-module 608 also acts as a software layer that can dynamically enable, disable, or adjust power transfer routes based on instructions received from Central Control Unit (CCU) 612. Central Control Unit (CCU) processes feedback and commands, coordinating with the BMS sensors sub-module 614 to optimize the performance of power transfer network (PTN).

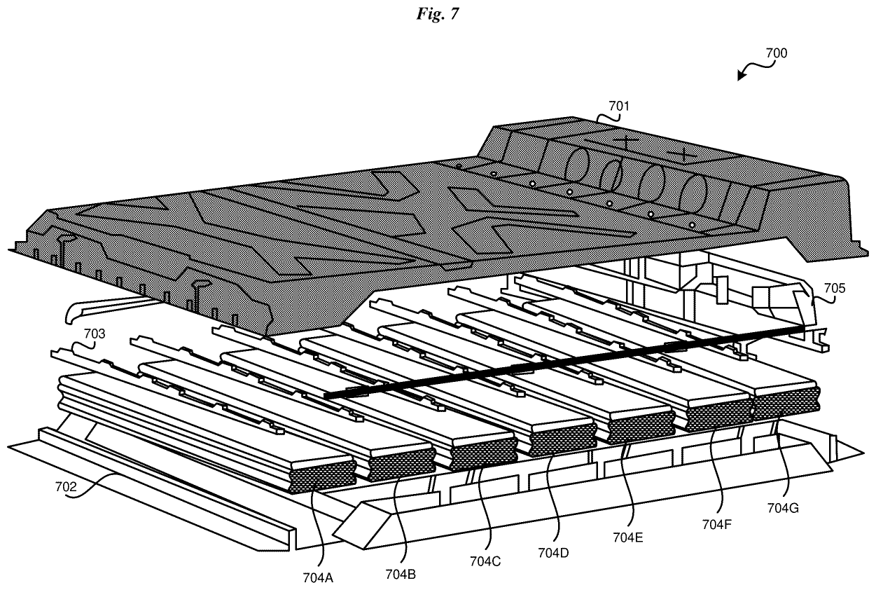

With reference to FIG. 7, this figure depicts block diagram of an example mechanical design 700 of a battery management system (BMS)/battery pack accordance with an illustrative embodiment. The mechanical design 700 of a battery management system (BMS) includes top cover 701 of the battery pack, railing 703 for securing battery cells, battery cells 704a-70g, and a bottom cover for the battery pack.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

1. A computer implemented method for optimizing a configuration for a battery pack, the computer implemented method comprising:
accessing, using a battery management system (BMS) associated with one or more battery cells in the battery pack, one or more settings associated with the one or more battery cells in the battery pack;
optimizing, based on the one or more settings associated with the one or more battery cells in the battery pack and battery power requirements, the configuration for the battery pack, until the configuration meets or exceeds the battery power requirements; and
configuring, using the battery management system (BMS) associated with the one or more battery cells in the battery pack, one or more specified settings associated with the one or more battery cells in the battery pack to facilitate power transfer between the one or more battery cells in the battery pack, using one or more wireless transfer paths associated the one or more battery cells in the battery pack, based on the optimized configuration.

2. The method of claim 1, wherein: the one or more settings further comprise one or more of the following: a voltage, a current, a capacity, a type of connection, and an identifier.

3. The method of claim 2, wherein: the battery power requirements further comprise one or more of the following: a voltage, a current, a capacity, and types of connection.

4. The method of claim 3, wherein: the one or more specified settings further comprise one or more of the following: a voltage, a current, a capacity, an identifier, and types of connection.

5. The method of claim 3, wherein: optimizing the configuration for the battery pack, until the configuration meets or exceeds the battery power requirements further comprises performing a predictive analysis.

6. The method of claim 5, wherein: the predictive analysis is a Bayesian optimization model.

7. The method of claim 4, wherein: the one or more wireless transfer paths are inductive power transfer paths.

8. The method of claim 4, further comprising:
electronically disabling the one or more battery cells in the battery pack, which were not included in the optimal configuration.

9. A computer usable program product comprising one or more computer readable storage media, and program instructions collectively stored on the one or more computer readable storage media, the program instructions executable by a processor to cause the processor to perform operations comprising:
accessing, using a battery management system (BMS) associated with one or more battery cells in a battery pack, one or more settings associated with the one or more battery cells in the battery pack;
optimizing, based on the one or more settings associated with the one or more battery cells in the battery pack and battery power requirements, a configuration for the battery pack, until the configuration meets or exceeds the battery power requirements; and
configuring, using the battery management system (BMS) associated with the one or more battery cells in the battery pack, one or more specified settings associated with the one or more battery cells in the battery pack to facilitate power transfer between the one or more battery cells in the battery pack, using one or more wireless transfer paths associated the one or more battery cells in the battery pack, based on the optimized configuration.

10. The computer usable program product of claim 9, wherein: the one or more settings further comprise one or more of the following: a voltage, a current, a capacity, a type of connection, and an identifier.

11. The computer usable program product of claim 10, wherein: the battery power requirements further comprise one or more of the following: a voltage, a current, a capacity, and types of connection.

12. The computer usable program product of claim 11, wherein: the one or more specified settings further comprise one or more of the following: a voltage, a current, a capacity, an identifier, and types of connection.

13. The computer usable program product of claim 10, wherein: optimizing the configuration for the battery pack, until the configuration meets or exceeds the battery power requirements further comprises performing a predictive analysis.

14. The computer usable program product of claim 13, wherein: the predictive analysis is a Bayesian optimization model.

15. The computer usable program product of claim 12, further comprising:
physically removing the one or more battery cells in the battery pack, which were not included in the optimal configuration.

16. The computer usable program product of claim 12, further comprising:
electronically disabling the one or more battery cells in the battery pack, which were not included in the optimal configuration.

17. A computer system comprising a processor and one or more computer readable storage media, and program instructions collectively stored on the one or more computer readable storage media, the program instructions executable by the processor to cause the processor to perform operations comprising:
accessing, using a battery management system (BMS) associated with one or more battery cells in a battery pack, one or more settings associated with the one or more battery cells in the battery pack;
optimizing, based on the one or more settings associated with the one or more battery cells in the battery pack and battery power requirements, a configuration for the battery pack, until the configuration meets or exceeds the battery power requirements; and
configuring, using the battery management system (BMS) associated with the one or more battery cells in the battery pack, one or more specified settings associated with the one or more battery cells in the battery pack to facilitate power transfer between the one or more battery cells in the battery pack, using one or more wireless transfer paths associated the one or more battery cells in the battery pack, based on the optimized configuration.

18. The computer system of claim 17, wherein: the one or more settings further comprise one or more of the following: a voltage, a current, a capacity, a type of connection, and an identifier.

19. The computer system of claim 18, wherein: the battery power requirements further comprise one or more of the following: a voltage, a current, a capacity, and types of connection.

20. The computer system of claim 19, wherein: the one or more specified settings further comprise one or more of the following: a voltage, a current, a capacity, an identifier, and types of connection.

21. A computer implemented method for optimizing a configuration for a battery pack, the computer implemented method comprising:
accessing, using a battery management system (BMS) associated with one or more battery cells in the battery pack, one or more settings associated with the one or more battery cells in the battery pack;
optimizing, based on the one or more settings associated with the one or more battery cells in the battery pack and battery power requirements, the configuration for the battery pack, until the configuration meets or exceeds the battery power requirements;
configuring, using the battery management system (BMS) associated with the one or more battery cells in the battery pack, one or more specified settings associated with the one or more battery cells in the battery pack to facilitate power transfer between the one or more battery cells in the battery pack, using one or more wireless transfer paths associated the one or more battery cells in the battery pack, based on the optimized configuration; and
authenticating, using the battery management system (BMS) associated with the one or more battery cells in the battery pack, the one or more battery cells in the battery pack, based on the optimized configuration.

22. The method of claim 21, wherein: the one or more settings further comprise one or more of the following: a voltage, a current, a capacity, a type of connection, and an identifier.

23. The method of claim 22, wherein: the battery power requirements further comprise one or more of the following: a voltage, a current, a capacity, and types of connection.

24. The method of claim 23, wherein: the one or more specified settings further comprise one or more of the following: a voltage, a current, a capacity, an identifier, and types of connection.

25. A computer usable program product comprising one or more computer readable storage media, and program instructions collectively stored on the one or more computer readable storage media, the program instructions executable by a processor to cause the processor to perform operations comprising:
accessing, using a battery management system (BMS) associated with one or more battery cells in a battery pack, one or more settings associated with one or more battery cells in the battery pack;
optimizing, based on the one or more settings associated with the one or more battery cells in the battery pack and battery power requirements, a configuration for the battery pack, until the configuration meets or exceeds the battery power requirements;
configuring, using the battery management system (BMS) associated with the one or more battery cells in the battery pack, one or more specified settings associated with the one or more battery cells in the battery pack to facilitate power transfer between the one or more battery cells in the battery pack, using one or more wireless transfer paths associated the one or more battery cells in the battery pack, based on the optimized configuration; and
authenticating, using the battery management system (BMS) associated with the one or more battery cells in the battery pack, the one or more battery cells in the battery pack, based on the optimized configuration.
